(19) United States
(12) Patent Application Publication
(10) Pub. No.: US 2025/0273240 A1
(43) Pub. Date: Aug. 28, 2025

(54) MAGNETIC RECORDING MEDIUM MANUFACTURING METHOD AND MAGNETIC READ/WRITE DEVICE

(71) Applicant: Resonac Hard Disk Corporation, Chiba (JP)

(72) Inventors: Takayuki FUKUSHIMA, Chiba (JP); Gohei KUROKAWA, Chiba (JP); Tomoo SHIGE, Chiba (JP); Keita KANAZU, Tokyo (JP)

(21) Appl. No.: 18/857,616

(22) PCT Filed: Apr. 19, 2023
(86) PCT No.: PCT/JP2023/015575

§ 371 Date: Oct. 17, 2024

(30) Foreign Application Priority Data
Apr. 22, 2022 (JP) 2022-070962

(51) Int. Cl. G11B 5/73; G11B 5/65; G11B 5/852

(52) U.S. Cl. CPC G11B 5/7362; G11B 5/657; G11B 5/852

(57) ABSTRACT

A magnetic recording medium manufacturing method for manufacturing a magnetic recording medium having a substrate, an underlayer, and a perpendicular magnetic layer having a L1₀ structure in this order, includes heating a surface of the perpendicular magnetic layer by LED light emitted from a LED light source after forming the perpendicular magnetic layer, to improve a crystal orientation of the perpendicular magnetic layer, wherein the underlayer includes a NaCl type compound, and the LED light has a center wavelength of less than 500 nm.

### TECHNICAL FIELD

The present invention relates to magnetic recording medium manufacturing methods and magnetic read/write devices.

### BACKGROUND ART

Magnetic recording media are popularly used as recording media for recording and storing various data. A magnetic recording medium is generally formed by laminating a soft magnetic layer, an underlayer, a perpendicular magnetic layer, and a protective layer in this order on a nonmagnetic substrate.

CoCr-based alloys are conventionally used for the perpendicular magnetic layer, but FePt alloys having a L1₀ ordered structure, for example, are known as materials having a higher perpendicular magnetic anisotropy than the CoCr-based alloys. Further, it is known that a heat treatment at a high temperature of 400° C. or higher is required for the L1₀ ordering of the FePt alloys (for example, refer to Patent Document 1).

For example, as the magnetic recording medium using the perpendicular magnetic layer including the Fept-based alloy, there is a disclosed heat assisted magnetic recording magnetic recording medium in which an orientation control underlayer formed using an alloy having a BCC structure including Cr as a main component, a (100)-oriented crystalline underlayer including W, a barrier layer including MgO having a NaCl type structure, and a magnetic layer including a FePt alloy having a Llo structure are successively laminated (for example, refer to Patent Document 2).

### PRIOR ART DOCUMENTS

### Patent Documents

Patent Document 1: Japanese Laid-Open Patent Publication No. 2011-40121
Patent Document 2: Japanese Laid-Open Patent Publication No. 2015-88197

### DISCLOSURE OF THE INVENTION

### Problems to be Solved by the Invention

As application ranges of the magnetic read/write devices increase, there are demands for further improvements in recording densities of magnetic recording media. As a method of increasing the recording density of the magnetic recording medium, there is a method of improving a crystal orientation of the perpendicular magnetic layer by increasing the heating temperature during the formation of the perpendicular magnetic layer.

However, when the heating temperature of the perpendicular magnetic layer is increased, the heating affects the underlayer, the soft magnetic layer, and the nonmagnetic substrate, thereby causing the following problems. That is, an element constituting the underlayer diffuses into other layers, and impairs functions of the other layers. The alloy constituting the soft magnetic layer becomes crystallized, and soft magnetic properties are impaired. A strain in the nonmagnetic substrate becomes relaxed to enlarge crystals included in the nonmagnetic substrate, and undulations are generated on the surface of the magnetic recording medium.

One object of an aspect of the present invention is to provide a magnetic recording medium manufacturing method capable of preventing the heat during the heating of the perpendicular magnetic layer from affecting other layers and the substrate.

### Means for Solving the Problems

The present invention has the following configurations.

(1) A magnetic recording medium manufacturing method for manufacturing a magnetic recording medium having a substrate, an underlayer, and a perpendicular magnetic layer having a L1₀ structure in this order, the magnetic recording medium manufacturing method comprising:
heating a surface of the perpendicular magnetic layer by LED light emitted from a LED light source after forming the perpendicular magnetic layer, to improve a crystal orientation of the perpendicular magnetic layer, wherein:
the underlayer includes a NaCl type compound, and
the LED light has a center wavelength of less than 500 nm.

(2) The magnetic recording medium manufacturing method according to (1), wherein the LED light emitted from the LED light source includes no LED light having a center wavelength of 500 nm or more.

(3) The magnetic recording medium manufacturing method according to (1) or (2), wherein the LED light has a center wavelength of less than 500 nm, heats a heating region having a diameter greater than or equal to 90 mm, a light intensity of 1.5 W/cm² to 15 W/cm², and a uniformity of the light intensity in the heating region within +15%.

(4) The magnetic recording medium manufacturing method according to any one of (1) to (3), wherein:
the underlayer includes a first underlayer in which a bcc alloy having Cr as a main component is (100)-oriented, a second underlayer in which a bcc alloy having W as a main component is (100)-oriented, and a third underlayer having MgO as the NaCl type compound as a main component, that are laminated in this order on the substrate, and
a film thickness of the second underlayer is (λ×0.1) nm or greater when the center wavelength is A nm.

(5) A magnetic read/write device comprising:
a magnetic recording medium manufactured by the method for manufacturing a magnetic recording medium according to any one of (1) to (4).

### Effects of the Invention

According to an aspect of the present invention, it is possible to provide a magnetic recording medium manufacturing method capable of preventing the heat during the heating of the perpendicular magnetic layer from affecting other layers and the substrate.

### BRIEF DESCRIPTION OF THE DRAWINGS

FIG. 1 is a cross sectional view generally illustrating an example of a configuration of a magnetic recording medium obtained by a magnetic recording medium manufacturing method according to an embodiment of the present invention.

FIG. 2 is a diagram generally illustrating an example of a magnetic read/write device using the magnetic recording medium manufactured by the magnetic recording medium manufacturing method according to the embodiment of the present invention.

FIG. 3 is a schematic view illustrating an example of a magnetic head.

### MODE OF CARRYING OUT THE INVENTION

Hereinafter, embodiments of the present invention will be described in detail. In order to facilitate understanding of the description, the same constituent elements are designated by the same reference numerals in the drawings, and a redundant description thereof will be omitted. In addition, the scale of each member in the drawings may be different from the actual scale. In the present specification, “to” indicating a numerical range includes numerical values described before and after “to” as a lower limit value and an upper limit value, respectively, unless indicated otherwise.

A magnetic recording medium manufacturing method according to the present embodiment will be described. Before describing the magnetic recording medium manufacturing method according to the embodiment of the invention, a magnetic recording medium obtained by the magnetic recording medium manufacturing method according to the present embodiment will be described.

### [Magnetic Recording Medium]

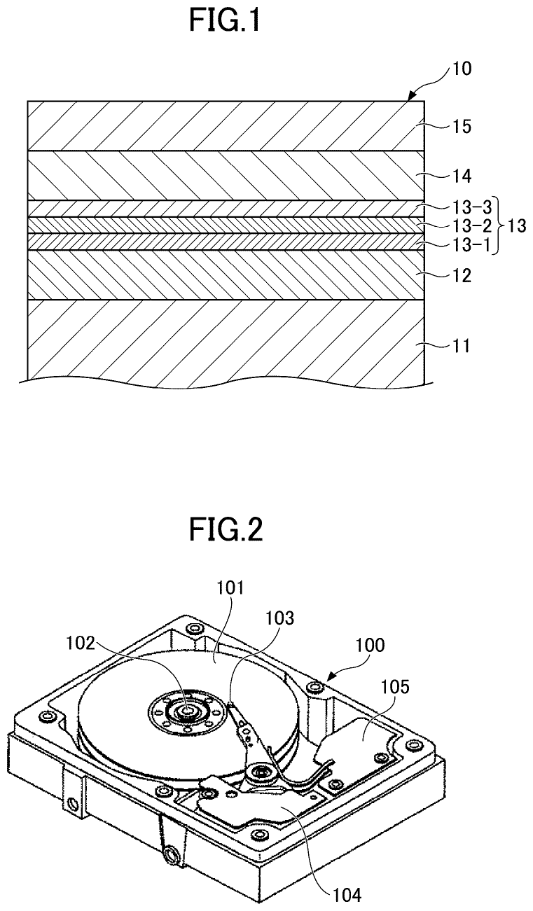

FIG. 1 is a cross sectional view generally illustrating an example of a configuration of the magnetic recording medium obtained by the magnetic recording medium manufacturing method according to the present embodiment. As illustrated in FIG. 1, a magnetic recording medium 10 includes a nonmagnetic substrate 11, a soft magnetic layer 12, an underlayer 13, a perpendicular magnetic layer 14, and a protective layer 15, which are laminated in this order from the side of the nonmagnetic substrate 11.

In FIG. 1, the side of the protective layer 15 is referred to as an upper side, and the side of the nonmagnetic substrate 11 is referred to as a lower side, but this does not represent a universal vertical relationship.

### (Nonmagnetic Substrate)

Examples of a material composing the nonmagnetic substrate 11 include Al alloys such as AlMg alloys or the like, soda glass, aluminosilicate-based glass, amorphous glasses, silicon, titanium, ceramics, sapphire, quartz, resins, or the like, for example. Among these materials, Al alloys, and glasses, such as crystallized glass, amorphous glass, or the like, are preferable.

For example, a heat-resistant glass substrate having a softening temperature of 500° C. or higher, preferably 600° C. or higher, is preferably used as the nonmagnetic substrate 11.

An outer diameter of the nonmagnetic substrate 11 is usually 2.5 inches or 3.5 inches.

### (Soft Magnetic Layer)

The soft magnetic layer 12 is provided on the nonmagnetic substrate 11, and has a function of guiding a recording magnetic field from a magnetic head, and efficiently applying a perpendicular component of the recording magnetic field on the perpendicular magnetic layer 14, when writing a signal on the magnetic recording medium 10.

Examples of a material composing the soft magnetic layer 12 include soft magnetic alloys, such as FeCo-based alloys, CoZrNb-based alloys, CoTaZr-based alloys, or the like.

The soft magnetic layer 12 preferably has an amorphous structure. In this case, because it is possible to enhance soft magnetic properties of the soft magnetic layer 12 and improve a surface smoothness of the soft magnetic layer 12, a flying height of the magnetic head can be reduced and a recording density of the magnetic recording medium 10 can further be improved.

The soft magnetic layer 12 may be formed as an antiferromagnetically coupled (AFC) film by forming a plurality of magnetic layers with a nonmagnetic layer, such as a Ru film or the like, interposed therebetween.

A total of the thicknesses of the soft magnetic layers 12 may be appropriately determined according to an electromagnetic conversion characteristics of the magnetic recording medium 10, but is preferably 20 nm to 120 nm, for example.

In the present specification, the thickness of the soft magnetic layer 12 refers to a length in a direction perpendicular to a main surface of the soft magnetic layer 12. The thickness of the soft magnetic layer 12 is the thickness measured at an arbitrary position in a cross section of the soft magnetic layer 12, for example. In a case where the thickness is measured at a plurality of arbitrary positions in the cross section of the soft magnetic layer 12, an average value of the thicknesses at these measurement positions may be used as the thickness of the soft magnetic layer 12. Hereinafter, measurement methods similar to that used to measure the thickness of the soft magnetic layer 12 may be used to measure the thickness of other layers other than the soft magnetic layer 12.

### (Underlayer)

The underlayer 13 includes a NaCl type compound, and preferably includes MgO as the NaCl type compound. Further, the underlayer 13 may have a multilayer structure including other layers, as long as the underlayer 13 can cause (001) orientation of magnetic grains having a L1₀ structure included in the perpendicular magnetic layer 14.

The underlayer 13 more preferably includes a bcc alloy, such as a Cr alloy, a W alloy, a Mo alloy, or the like, for example. Each of these alloys may be used by itself, or a combination of two or more of these alloys may be used. In addition, a layer using these materials may have a multilayer structure.

The underlayer 13 is preferably formed by laminating a plurality of different kinds of layers. In the present embodiment, as illustrated in FIG. 1, the underlayer 13 includes a first underlayer 13-1, a second underlayer 13-2, and a third underlayer 13-3. The underlayer 13 may include one or more layers other than the first underlayer 13-1, the second underlayer 13-2, and the third underlayer 13-3, such as a fourth underlayer 13-4, . . . .

The first underlayer 13-1 is preferably formed of a layer in which a bcc alloy including Cr is (100)-oriented. Specific examples of the bcc alloy include Cr, CrV, VCr, CrVTi, VCrTi, CrTa, and VCrTa.

The second underlayer 13-2 is laminated on the first underlayer 13-1, and is preferably formed of a layer in which a bcc alloy including any of W, Mo, V, and Ta as a main component is (100)-oriented. The layer composed of these materials may use a bcc alloy having a lattice constant of 3.06 Å to 3.16 Å.

W, Mo, 80at % V-20at % Ta (V-content of 80 at % and Ta-content of 20 at %, and similar representations used hereinafter), 90at % Mo-10at % Ta, 90at % W-10at % Ta, VMo, or the like is preferably used for the second underlayer 13-2.

The second underlayer 13-2 preferably has a thickness of (λ×0.1) nm to 100 nm, where λ denotes a center wavelength of irradiating light having a center wavelength of less than 500 nm. For example, in a case where light having a center wavelength of 400 nm is used, the thickness of the second underlayer 13-2 is more preferably 40 nm to 100 nm. By setting the thickness of the second underlayer 13-2 within the preferable range described above, it is possible to prevent heat generated by the irradiating light from affecting the side of the nonmagnetic substrate 11 from the second underlayer 13-2, prevent mutual diffusion between the first underlayer 13-1 and the second underlayer 13-2, and reduce expansion and contraction of the atomic lattice of the second underlayer 13-2, so that tensile stress can be applied to the third underlayer 13-3 and the perpendicular magnetic layer 14, and cause stable (001) face orientation of the perpendicular magnetic layer 14. In addition, because the heat generated by the irradiating light is prevented from reaching the soft magnetic layer 12 and the nonmagnetic substrate 11, crystallization of the alloy composing the soft magnetic layer 12 and relaxation of the strain of the nonmagnetic substrate 11 can be prevented.

The third underlayer 13-3 is laminated on the second underlayer 13-2, and preferably includes, as a main component, MgO as the NaCl type compound. By including MgO as the main component, the third underlayer 13-3 can cause the (001) orientation of the magnetic grains having the L1₀ structure included in the perpendicular magnetic layer 14.

### (Perpendicular Magnetic Layer)

The perpendicular magnetic layer 14 includes the magnetic grains having the L1₀ structure. Examples of the magnetic grains having the L1₀ structure include FePt-based alloy grains including FePt-based alloys, CoPt-based alloy grains including CoPt-based alloys, or the like.

A grain diameter of the magnetic grains is preferably 3 nm to 10 nm, and more preferably 4 nm to 7 nm. The grain diameter of the magnetic grains can be measured by a general measurement method, such as TEM observation of a plane, or the like.

A distances between the magnetic grains is preferably 4 nm to 12 nm, and more preferably 5 nm to 9 nm. The distance between the magnetic grains refers to a distance between centers of gravity of adjacent magnetic grains. The distance between the magnetic grains can be measured by a general measurement method, such as a TEM observation of a plane, or the like.

Moreover, the perpendicular magnetic layer 14 may have a granular structure including grain boundary portions.

In a case where the perpendicular magnetic layer 14 has the granular structure, a content of the grain boundary portions in the perpendicular magnetic layer 14 is preferably 25 vol % to 50 vol %, and more preferably 35 vol % to 45 vol %. When the content of the grain boundary portions in the perpendicular magnetic layer 14 falls within the preferable range described above, an anisotropy of the magnetic grains included in the perpendicular magnetic layer 14 can be increased.

The grain boundary portions may include a carbide, a nitride, an oxide, a boride, or the like. Specific examples of the material included in the grain boundary portions include BN, B₄C, C, MoO₃, GeO₂, or the like.

The magnetic grains are preferably c-axis oriented, that is, (001) oriented, with respect to the surface of the nonmagnetic substrate 11.

The perpendicular magnetic layer 14 has a thickness that is preferably 8 nm to 20 nm, more preferably 10 nm to 18 nm, and still more preferably 10 nm to 15 nm. When the thickness of the perpendicular magnetic layer 14 falls within the preferable range described above, a high recording density can be achieved.

The perpendicular magnetic layer 14 can be formed on the underlayer 13 by a sputtering method or the like.

The perpendicular magnetic layer 14 may include a single magnetic layer or may include a plurality of magnetic layers that are laminated. In a case where the perpendicular magnetic layer 14 includes the plurality of magnetic layers, the magnetic layers may be formed using the same kind of material or different kinds of materials. In addition, a nonmagnetic layer may be provided between adjacent magnetic layers. The nonmagnetic layer may be formed using a general material used in magnetic recording media.

### (Protective Layer)

The protective layer 15 has a function of protecting the magnetic recording medium 10 from damage or the like due to contact between the magnetic head and the magnetic recording medium 10.

Examples of a material used for the protective layer 15 include a carbon material, such as diamond-like carbon (DLC), or the like, for example.

The protective layer 15 has a thickness that is preferably 1 nm to 10 nm, and more preferably 2 nm to 6 nm.

In the present embodiment, the magnetic recording medium 10 may include a lubricant layer (not illustrated) provided on the protective layer 15. Examples of a material used for the lubricant layer include resins, such as perfluoropolyether or the like, for example. A thickness of the lubricant layer is not particularly limited, and may be appropriately formed to an arbitrary thickness of approximately 1.5 nm, for example.

In the present embodiment, the magnetic recording medium 10 may include a Ti-based underlayer including Cr and Ti, provided between the nonmagnetic substrate 11 and the soft magnetic layer 12. A thickness of the Ti-based underlayer is not particularly limited, and may be appropriately formed to an arbitrary thickness.

In the present embodiment, the magnetic recording medium 10 may include a Ta-based underlayer including Ta, provided between the soft magnetic layer 12 and the underlayer 13. The Ta-based underlayer may be composed solely of Ta. A thickness of the Ta-based underlayer is not particularly limited, and may be appropriately formed to an arbitrary thickness.

### [Magnetic Recording Medium Manufacturing Method]

The magnetic recording medium manufacturing method according to the present embodiment includes the steps of forming the soft magnetic layer 12, forming the underlayer 13, forming the perpendicular magnetic layer 14, and forming the protective layer 15, and may include other steps such as forming the lubricant layer or the like.

In the magnetic recording medium manufacturing method according to the present embodiment, first, the soft magnetic layer 12 is formed on the prepared nonmagnetic substrate 11 (soft magnetic layer forming step).

As a method of forming the soft magnetic layer 12, a general film forming method, such as a sputtering method or the like, can be used.

The sputtering method can use a target including a material for forming the soft magnetic layer 12.

Examples of the target including the material for forming the soft magnetic layer 12 include soft magnetic alloys, such as FeCo-based alloys, CoZrNb-based alloys, CoTaZr-based alloys, or the like, for example.

A DC sputtering method, a DC magnetron sputtering method, a RF sputtering method, or the like can be used for the sputtering method.

When forming the soft magnetic layer 12, a radio frequency (RF) bias, a DC bias, a pulse DC, a pulse DC bias, or the like may be used, as required.

A O₂ gas, H₂O gas, N₂ gas, or the like may be used as a reactive gas.

A sputtering gas pressure is appropriately adjusted so as to optimize the characteristics of each layer, and is usually set in a range of approximately 0.1 Pa to approximately 30 Pa.

Next, the underlayer 13 is formed on the soft magnetic layer 12 (underlayer forming step).

The underlayer forming step may include the steps of forming a first underlayer, forming a second underlayer, and forming a third underlayer.

The first underlayer 13-1 can be formed by the sputtering method using a target including the material for forming the first underlayer 13-1, similar to the method of forming the soft magnetic layer 12.

A target including the material for forming the first underlayer 13-1 can be used as the target including the material for forming the first underlayer 13-1. The material for forming the first underlayer 13-1 may be a Cr alloy in which a bcc alloy including Cr as a main component is (100)-oriented, or the like.

Sputtering conditions other than the material for forming the underlayer 13 may be the same as the sputtering conditions for the soft magnetic layer 12.

The second underlayer 13-2 can be formed by the sputtering method using a target including a material for forming the second underlayer 13-2, similar to the method of forming the soft magnetic layer 12.

A target including the material for forming the second underlayer 13-2 may be used as the target including the material for forming the second underlayer 13-2. The material for forming the second underlayer 13-2 may be a W alloy in which a bcc alloy including W as a main component is (100)-oriented, or the like.

Sputtering conditions other than the material for forming the second underlayer 13-2 may be the same as the sputtering conditions for the soft magnetic layer 12.

The third underlayer 13-3 can be formed by the sputtering method using a target including a material for forming the third underlayer 13-3, similar to the method of forming the soft magnetic layer 12.

A target including the material for forming the third underlayer 13-3 may be used as the target including the material for forming the third underlayer 13-3. The material for forming the third underlayer 13-3 may be a NaCl type compound or the like. MgO or the like can be used as the NaCl type compound.

Sputtering conditions other than the material for forming the third underlayer 13-3 may be the same as the sputtering conditions for the soft magnetic layer 12.

Next, the perpendicular magnetic layer 14 is formed on the underlayer 13 (perpendicular magnetic layer forming step).

The perpendicular magnetic layer 14 can be formed by the sputtering method using a target including a material for forming the perpendicular magnetic layer 14, similar to the method of forming the soft magnetic layer 12.

A target including an alloy having the Llo structure can be used as the target including the material for forming the perpendicular magnetic layer 14. Alloys including Fe or Co, Pt, or the like, such as FePt alloys, CoPt alloys, or the like, for example, can be used as the alloy having the L1₀ structure.

Sputtering conditions other than the material for forming the perpendicular magnetic layer 14 may be the same as the sputtering conditions for the soft magnetic layer 12.

Next, a surface of the perpendicular magnetic layer 14 is heated by LED light emitted from an LED light source in a state where the perpendicular magnetic layer 14 is laminated on a laminate of the nonmagnetic substrate 11, the soft magnetic layer 12, and the underlayer 13, thereby enhancing the crystal orientation of the perpendicular magnetic layer 14 (heating step).

The LED light source preferably emits LED light having a center wavelength of less than 500 nm, a heating region having a diameter greater than or equal to 90 mm, a light intensity of 1.5 W/cm² to 15 W/cm², and a uniformity of the light intensity in the heating region within +15%. Thus, the LED light source can efficiently heat only the perpendicular magnetic layer 14 by the LED light.

The uniformity of the light intensity in the heating region is measured at a heating position of the LED light source, that is, at a portion corresponding to the heating surface of the perpendicular magnetic layer 14. A known measurement method may be used, and for example, a light intensity meter is placed at the position of the nonmagnetic substrate 11 to measure an in-plane distribution of the light intensity on the substrate surface, and a fluctuation range with respect to an average value of the light intensity distribution is calculated.

In addition, it is preferable to use an LED light source such that the LED light emitted from the LED light source includes no LED light having a center wavelength of 500 nm or more.

As described above, it is known that the heat treatment at the high temperature of 400° C. or higher is generally required for the ordering of the FePt alloy having the L1₀ ordered structure. Conventionally, a halogen lamp, a laser, and electromagnetic waves, such as high-frequency waves, microwaves, or the like are used for the heat treatment. However, in a case where the halogen lamp is used, the entire region from the nonmagnetic substrate 11 to the perpendicular magnetic layer 14 becomes heated because an irradiation wavelength of the halogen lamp is approximately 500 nm to approximately 3.5 μm and wide. In a case where the laser is used, only a specific substance can be heated by oscillating the laser at a specific wavelength, but the laser has a narrow irradiation area, and it is difficult to uniformly heat the entire surface of the perpendicular magnetic layer 14. In a case where the electromagnetic waves are used, a heating efficiency of the electromagnetic waves depends on a dielectric constant of an object to be heated, and for this reason, the electromagnetic waves are not suitable for heating only the perpendicular magnetic layer 14.

In the present embodiment, the perpendicular magnetic layer 14 can be efficiently heated using the LED light emitted from the LED light source for heating the perpendicular magnetic layer 14. That is, Fe, Pt, and Co included in the perpendicular magnetic layer 14 have light absorption peaks on the short wavelength side below 500 nm. The LED light emitted from the LED light source of the present embodiment has a wide heating region and a high uniformity of light intensity in the heating region, and thus, the entire region of the perpendicular magnetic layer 14 can be heated substantially uniformly.

In addition, because the NaCl type compound included in the third underlayer 13-3 has a light absorption peak at 500 nm or above, the temperature is unlikely to rise by heating solely by the LED light, and the NaCl type compound has a heat insulation effect. For this reason, during the heating treatment of the perpendicular magnetic layer 14, the temperature rise of the nonmagnetic substrate 11, the soft magnetic layer 12, and the underlayer 13 can be prevented.

A light penetration depth is determined by the wavelength of the light, and the depth may be regarded as being approximately 0.1λ nm (λ is the center wavelength (unit: nm) of irradiating light), and thus, the light emitted from the conventional halogen lamp penetrates into a deep layer and heats the deep layer. In contrast, the LED light emitted from the LED light source is less likely to penetrate into the deep layer from the irradiation surface, and the heating effect is reduced. Hence, by setting the layer thickness of the second underlayer 13-2 to 0.1λ nm to 100 nm, the temperature rise of the layers under the second underlayer 13-2 can further be prevented. Moreover, by increasing the layer thickness of the second underlayer 13-2, the tensile stress applied to the third underlayer 13-3, which is the NaCl type compound layer, can be increased.

Because the nonmagnetic substrate 11 usually has the outer diameter of 2.5 inches or 3.5 inches, the entire nonmagnetic substrate 11 can be uniformly heated by setting the diameter of the heating region to be heated by the LED light source to 90 mm or greater.

Although Cr included in the first underlayer 13-1 is an element that is easily thermally diffused, a thermal diffusion at the interface between the first underlayer 13-1 and the second underlayer 13-2 can be prevented by the heat insulation effect between the second underlayer 13-2 and the third underlayer 13-3 which is the layer including the NaCl type compound. Accordingly, diffusion of Cr atoms into the second underlayer 13-2, such as a W alloy layer or the like, can be prevented, thereby preventing a lattice shrinkage of the second underlayer 13-2 due to substitution of W atoms for Cr atoms. Consequently, the tensile stress applied to the third underlayer 13-3 including MgO as the main component is reduced, thereby preventing the ordering of the FePt alloy or the like included in the perpendicular magnetic layer 14 from becoming inhibited.

In addition, the heat insulation effects of the second underlayer 13-2 and the third underlayer 13-3 can prevent the heating of the soft magnetic layer 12 located under the first underlayer 13-1, thereby preventing the crystallization of the soft magnetic layer 12.

Moreover, because the second underlayer 13-2 has the heat insulation effect, it is not necessary to increase the thickness of the third underlayer 13-3, which is the layer including the NaCl type compound, and thus, it is possible to reduce a decrease in the tensile stress due to an increase in the thickness of the third underlayer 13-3.

Further, because the heating of the nonmagnetic substrate 11 located under the first underlayer 13-1 is prevented by the heat insulation effects of the second underlayer 13-2 and the third underlayer 13-3, it is possible to reduce the generation of undulations caused by the strain that is relaxed and the crystals that are enlarged.

Next, the protective layer 15 is formed on the perpendicular magnetic layer 14 (step of forming the protective layer 15).

The method of forming the protective layer 15 is not particularly limited, and a general film forming method, such as radio frequency-chemical vapor deposition (RF-CVD) which forms a film by decomposing a source gas formed of hydrocarbon by high-frequency plasma, an ion beam deposition (IBD) which forms a film by ionizing the source gas by electrons emitted from a filament, a filtered cathodic vacuum arc (FCVA) which forms a film using a solid carbon target without using a source gas, or the like can be used.

In addition, the lubricant layer 16 may be formed on a surface of the protective layer 15, using a general coating method or the like (lubricant layer forming step).

As described above, the magnetic recording medium 10 illustrated in FIG. 1 is obtained by forming the protective layer 15 on the perpendicular magnetic layer 14.

As described above, the magnetic recording medium manufacturing method according to the present embodiment includes the perpendicular magnetic layer forming step, and the perpendicular magnetic layer heating step, and in the perpendicular magnetic layer heating step, the surface of the perpendicular magnetic layer 14 is heated by the LED light emitted from the LED light source. The LED light source emits the LED light having the center wavelength of less than 500 nm. Thus, the magnetic recording medium manufacturing method according to the present embodiment can heat the entire region of only the perpendicular magnetic layer 14 substantially uniformly by the LED light emitted from the LED light source, and can prevent the LED light from reaching and heating the nonmagnetic substrate 11, the soft magnetic layer 12, and the underlayer 13 located under the perpendicular magnetic layer 14. Accordingly, the magnetic recording medium manufacturing method according to the present embodiment can efficiently heat only the perpendicular magnetic layer 14, and prevent the effects of the heat from reaching the nonmagnetic substrate 11, the soft magnetic layer 12, and the underlayer 13 located under the perpendicular magnetic layer 14.

In the magnetic recording medium manufacturing method according to the present embodiment, the heating temperature of the perpendicular magnetic layer 14 can further be increased by the LED light, and thus, the crystal orientation of the perpendicular magnetic layer 14 can further be increased. In addition, the magnetic recording medium manufacturing method according to the present embodiment can prevent the diffusion of the element constituting the underlayer 13 into the soft magnetic layer 12 due to the heat during heating of the perpendicular magnetic layer 14, and can prevent a deterioration of the soft magnetic properties of the soft magnetic layer 12 due to the inhibition of the amorphous structure of the soft magnetic layer 12. Further, it is possible to prevent the generation of the undulations on the nonmagnetic substrate 11 due to the heat during the heating of the perpendicular magnetic layer 14. Hence, the magnetic recording medium manufacturing method according to the present embodiment can manufacture the magnetic recording medium 10 having little undulation on the surface of the magnetic recording medium 10 and having excellent electromagnetic conversion characteristics.

In the magnetic recording medium manufacturing method according to the present embodiment, the LED light source can be configured such that the LED light emitted from the LED light source includes no LED light having a center wavelength of 500 nm or more. Because the third underlayer 13-3 has the light absorption peak at 500 nm or above, the temperature rise due to the LED light is unlikely to occur, and the third underlayer 13-3 can have the heat insulation effect. For this reason, in the magnetic recording medium manufacturing method according to the present embodiment, during the heating step of the perpendicular magnetic layer 14, it is possible to prevent the temperature rise of the nonmagnetic substrate 11, the soft magnetic layer 12, and the underlayer 13 located under the perpendicular magnetic layer 14, and positively prevent the heat from affecting the these members.

In the magnetic recording medium manufacturing method according to the present embodiment, the LED light that is irradiated has the center wavelength of less than 500 nm, the heating region having the diameter greater than or equal to 90 mm, the light intensity of 1.5 W/cm² to 15 W/cm², and the uniformity of the light intensity in the heating region within +15%. Thus, the magnetic recording medium manufacturing method according to the present embodiment can heat only the perpendicular magnetic layer 14 more uniformly over the entire region thereof by the LED light, and can further prevent the LED light from reaching and heating the nonmagnetic substrate 11, the soft magnetic layer 12, and the underlayer 13 located under the perpendicular magnetic layer 14. Hence, the magnetic recording medium manufacturing method according to the present embodiment can more efficiently heat only the perpendicular magnetic layer 14, and can further prevent the heat from affecting the nonmagnetic substrate 11, the soft magnetic layer 12, and the underlayer 13 located under the perpendicular magnetic layer 14.

In the magnetic recording medium manufacturing method according to the present embodiment, the underlayer 13 may include the first underlayer 13-1, the second underlayer 13-2, and the third underlayer 13-3 laminated in this order from the side of the nonmagnetic substrate 11, and the film thickness of the second underlayer 13-2 may be (λ×0.1) nm or greater when the center wavelength is λ nm. Thus, the magnetic recording medium manufacturing method according to the present embodiment can more positively prevent the temperature rise of the nonmagnetic substrate 11 and the soft magnetic layer 12 located under the second underlayer 13-2 due to the LED light, and increase the tensile stress of the third underlayer 13-3. For this reason, according to the magnetic recording medium manufacturing method according to the present embodiment, it is possible to more positively prevent the heat caused by the LED light from affecting the nonmagnetic substrate 11 and the soft magnetic layer 12 located under the second underlayer 13-2, and improve the electromagnetic conversion characteristics of the magnetic recording medium 10.

### [Magnetic Read/Write Device]

A magnetic read/write device using the magnetic recording medium manufactured by the magnetic recording medium manufacturing method according to the present embodiment will be described. A configuration of the magnetic read/write device according to the present embodiment is not particularly limited as long as the magnetic read/write device includes the magnetic recording medium manufactured by the magnetic recording medium manufacturing method according to the present embodiment. A case where the magnetic read/write device magnetically writes information on the magnetic recording medium using the heat assisted recording method will be described.

FIG. 2 is a diagram generally illustrating an example of the magnetic read/write device using the magnetic recording medium manufactured by the magnetic recording medium manufacturing method according to the present embodiment of the present invention. As illustrated in FIG. 2, a magnetic read/write device 100 may include a magnetic recording medium 101, a magnetic recording medium drive unit 102 for rotating the magnetic recording medium 101, a magnetic head 103 having a near-field light generating element provided on a tip end thereof, a magnetic head drive unit 104 for moving the magnetic head 103, and a read/write signal processor 105. The magnetic recording medium 10 manufactured by the magnetic recording medium manufacturing method according to the present embodiment described above is used as the magnetic recording medium 101.

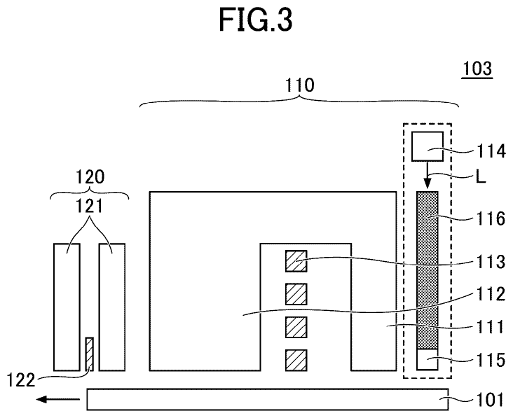

FIG. 3 is a schematic view illustrating an example of the magnetic head 103. As illustrated in FIG. 3, the magnetic head 103 includes a write head 110 and a read head 120.

The write head 110 includes a main magnetic pole 111, an auxiliary magnetic pole 112, a coil 113 configured to generate a magnetic field, a laser diode (LD) 114, which forms a laser light generator configured to heat the magnetic recording medium 101, and a waveguide 116 configured to transmit a laser L generated from the LD 114 to a near-field light generating element 115.

The read head 120 includes shields 121, and a read element 122 sandwiched between the shields 121.

As illustrated in FIG. 3, in the magnetic read/write device 100, a central portion of the magnetic recording medium 101 is attached to a rotating shaft of a spindle motor, and information is written on or read from the magnetic recording medium 101 in a state where the magnetic head 103 moves while floating above a surface of the magnetic recording medium 101 which is driven to rotate by the spindle motor.

The magnetic read/write device 100 according to the present embodiment uses the magnetic recording medium 101 manufactured by the magnetic recording medium manufacturing method according to the present embodiment, and thus, the magnetic recording medium 101 can have excellent electromagnetic conversion characteristics, and stably have a high recording density.

### EXEMPLARY IMPLEMENTATIONS

Hereinafter, the embodiment will be described in detail with reference to exemplary implementations and comparative examples, but the embodiment is not limited to these exemplary implementations and comparative examples.

### Exemplary Implementation 1

### [Manufacturing of Magnetic Recording Medium]

A magnetic recording medium was manufactured by the following method.

First, after depositing a Ti-based underlayer composed of 50at % Cr-50at % Ti (a Cr-content of 50 at % and a Ti-content of 50 at %) and having a thickness of 50 nm on a glass substrate having an outer diameter of 2.5 inches, a 40at&Co-46at&Fe-14% B soft magnetic layer having a thickness of 150 nm was deposited. Thereafter, after heating the glass substrate to 320° C. by a halogen lamp, an underlayer composed of Ta and having a thickness of 10 nm, a first underlayer composed of 42.5at % Cr-50at % V-7.5at % Ti and having a thickness of 10 nm, a second underlayer composed of W and having a thickness of 60 nm, a third underlayer composed of MgO and having a thickness of 3 nm, and a perpendicular magnetic layer composed of 82 mol % (50at % Fe-50at % Pt)-10 mol % SiO₂−8 mol % BN (a content of 82 mol % of a FePt alloy with a Fe-content of 50 at % and a Pt-content of 50 at %, a content of 10 mol % of SiO₂, and a content of 8 mol % of BN) and having a thickness of 10 nm are deposited.

Thereafter, the LED light from the LED light source was irradiated on the surface of the perpendicular magnetic layer to heat the surface of the perpendicular magnetic layer by the LED light. The LED light source emitted LED light having a center wavelength of 395 nm (including no light having the center wavelength of 500 nm or more), an irradiating region (heating region) having a diameter of 100 mm (effective area), a light intensity of 11 W/cm² within the effective area, and a uniformity of the light intensity in the effective area within +7%, a heating time was 10 seconds, and a surface temperature of the perpendicular magnetic layer was 550° C. at a maximum.

Thereafter, a protective layer composed of diamond-like carbon (DLC) and having a thickness of 4 nm was deposited on the perpendicular magnetic layer, and a liquid lubricant layer composed of perfluoropolyether and having a thickness of 1.5 nm was thereafter formed by coating.

The magnetic recording medium was manufactured by the steps described above. The film thickness of the third underlayer, and the heating conditions (heating means, center wavelength, wavelength range, light intensity, uniformity of light intensity (light intensity uniformity), and presence or absence of light having the center wavelength of 500 nm or more) are illustrated in Table 1 and Table 2.

### [Evaluation of Characteristics of Magnetic Recording Medium]

The orientation of the perpendicular magnetic layer, and the SNR representing the electromagnetic conversion characteristics, were measured and evaluated as the characteristics of the magnetic recording medium.

### (Measurement of Orientation of Perpendicular Magnetic Layer)

The (001) intensity of the FePt alloy composing the perpendicular magnetic layer was measured using an X-ray diffraction apparatus, and the (001) orientation of the perpendicular magnetic layer was evaluated. The measurement results of the (001) intensity of the FePt alloy are illustrated in Table 1 and Table 2.

### (Measurement of Electromagnetic Conversion Characteristics)

The electromagnetic conversion characteristics (SNR) were measured by a spin stand tester using a magnetic head equipped with a laser spot heating mechanism. In this case, a current applied to the laser diode was adjusted, so that a recording track length (MWW), defined as a half-value width of the read signal waveform, becomes 70 nm, and the SNR was checked. The measurement results of SNR are illustrated in Table 1 and Table 2.

### Exemplary Implementations 2 through 14

The manufacturing steps were the same as the exemplary implementation, except for the thickness of the second underlayer, and the heating conditions (heating means, center wavelength, wavelength range, light intensity, light intensity uniformity, and presence or absence of light having the center wavelength of 500 nm or more), which were changed to the conditions illustrated in Table 1 and Table 2.

### Comparative Examples 1 through 7

The manufacturing steps were the same as the exemplary implementation 1, except for the thickness of the second underlayer, and the heating conditions (heating means, center wavelength, wavelength range, light intensity, light intensity uniformity, and presence or absence of light having the center wavelength of 500 nm or more), which were changed to the conditions illustrated in Table 1 and Table 2. In addition, in the comparative examples 3, 5, and 6, a halogen lamp was used for the heating of the perpendicular magnetic layer, the heating time was 10 seconds, and the surface temperature of the perpendicular magnetic layer was 550° C. at the maximum. The halogen lamps used had a center wavelength of 1000 nm, and a wavelength range of 350 nm to 3500 nm. In the comparative example 4, high-frequency waves were used. The heating time was 10 seconds, and the surface temperature of the perpendicular magnetic layer was 550° C. at the maximum. An oscillation frequency of the high-frequency waves was 13.56 MHZ, and a maximum power was 1 kW.

TABLE 1

| | | | THIRD | |
|---|---|---|---|---|
| | | | UNDERLAYER | |
| | FIRST | SECOND | | FILM |
| | UNDERLAYER | UNDERLAYER | | THICKNESS |
| | MATERIAL | MATERIAL | MATERIAL | [nm] |
| EXEMPLARY IM- | 50V—42.5Cr—7.5Ti | W | MgO | 60 |
| PLEMENTATION 1 | | | | |
| EXEMPLARY IM- | 50V—42.5Cr—7.5Ti | W | MgO | 60 |
| PLEMENTATION 2 | | | | |
| EXEMPLARY IM- | 50V—42.5Cr—7.5Ti | W | MgO | 60 |
| PLEMENTATION 3 | | | | |
| EXEMPLARY IM- | 50V—42.5Cr—7.5Ti | W | MgO | 60 |
| PLEMENTATION 4 | | | | |
| EXEMPLARY IM- | 50V—42.5Cr—7.5Ti | W | MgO | 50 |
| PLEMENTATION 5 | | | | |
| EXEMPLARY IM- | 50V—42.5Cr—7.5Ti | W | MgO | 40 |
| PLEMENTATION 6 | | | | |
| EXEMPLARY IM- | 50V—42.5Cr—7.5Ti | W | MgO | 30 |
| PLEMENTATION 7 | | | | |
| EXEMPLARY IM- | 90Cr—10Ta | W | MgO | 50 |
| PLEMENTATION 8 | | | | |
| EXEMPLARY IM- | 50V—40Cr—10Ta | W | MgO | 50 |
| PLEMENTATION 9 | | | | |
| EXEMPLARY IM- | 50V—50Cr | W | MgO | 50 |
| PLEMENTATION 10 | | | | |
| EXEMPLARY IM- | 50V—42.5Cr—7.5Ti | 80V—20Ta | MgO | 50 |
| PLEMENTATION 11 | | | | |
| EXEMPLARY IM- | 50V—42.5Cr—7.5Ti | Mo | MgO | 50 |
| PLEMENTATION 12 | | | | |
| EXEMPLARY IM- | 50V—42.5Cr—7.5Ti | 90Mo—10Ta | MgO | 50 |
| PLEMENTATION 13 | | | | |
| EXEMPLARY IM- | 50V—42.5Cr—7.5Ti | 90V—10Mo | MgO | 50 |
| PLEMENTATION 14 | | | | |
| COMPARATIVE | 50V—42.5Cr—7.5Ti | W | MgO | 60 |
| EXAMPLE 1 | | | | |
| COMPARATIVE | 50V—42.5Cr—7.5Ti | W | MgO | 60 |
| EXAMPLE 2 | | | | |
| COMPARATIVE | 50V—42.5Cr—7.5Ti | W | MgO | 60 |
| EXAMPLE 3 | | | | |
| COMPARATIVE | 50V—42.5Cr—7.5Ti | W | MgO | 60 |
| EXAMPLE 4 | | | | |
| COMPARATIVE | 50V—42.5Cr—7.5Ti | W | MgO | 50 |
| EXAMPLE 5 | | | | |
| COMPARATIVE | 50V—42.5Cr—7.5Ti | W | MgO | 40 |
| EXAMPLE 6 | | | | |
| COMPARATIVE | 50V—42.5Cr—7.5Ti | W | MgO | 40 |
| EXAMPLE 7 | | | | |

TABLE 2

| | PERPENDICULAR MAGNETIC LAYER | | | | | | | |
|---|---|---|---|---|---|---|---|---|
| | HEATING CONDITION | | | | | | CHARAC- | |
| | | | | | | LIGHT OF | TERISTIC | MAGNETIC |
| | | CENTER | WAVE- | LIGHT | LIGHT | CENTER WAVE- | (001) | RECORDING |
| | | WAVE- | LENGTH | INTEN- | INTENSITY | LENGTH OF | INTENSITY | MEDIUM |
| | HEATING | LENGTH | RANGE | SITY | UNIFORMITY | 500 nm OR | OF FePt | SNR |
| | MEANS | [nm] | [nm] | [W/cm²] | [±%] | HIGHER | ALLOY | [dB] |
| EXEMPLARY IM- | LED | 395 | 385-405 | 11 | 7 | NOT | 207.0 | 2.68 |
| PLEMENTATION 1 | LAMP | | | | | INCLUDED | | |
| EXEMPLARY IM- | LED | 395 | 385-405 | 5.5 | 7 | NOT | 207.7 | 2.76 |
| PLEMENTATION 2 | LAMP | | | | | INCLUDED | | |
| EXEMPLARY IM- | LED | 395 | 385-405 | 3.6 | 7 | NOT | 208.8 | 2.83 |
| PLEMENTATION 3 | LAMP | | | | | INCLUDED | | |
| EXEMPLARY IM- | LED | 395 | 385-405 | 1.8 | 7 | NOT | 209.4 | 2.91 |
| PLEMENTATION 4 | LAMP | | | | | INCLUDED | | |
| EXEMPLARY IM- | LED | 395 | 385-405 | 3.6 | 7 | NOT | 207.9 | 2.81 |
| PLEMENTATION 5 | LAMP | | | | | INCLUDED | | |
| EXEMPLARY IM- | LED | 395 | 385-405 | 3.6 | 7 | NOT | 206.3 | 2.79 |
| PLEMENTATION 6 | LAMP | | | | | INCLUDED | | |
| EXEMPLARY IM- | LED | 395 | 385-405 | 3.6 | 7 | NOT | 205.8 | 2.71 |
| PLEMENTATION 7 | LAMP | | | | | INCLUDED | | |
| EXEMPLARY IM- | LED | 395 | 385-405 | 3.6 | 7 | NOT | 206.1 | 2.77 |
| PLEMENTATION 8 | LAMP | | | | | INCLUDED | | |
| EXEMPLARY IM- | LED | 395 | 385-405 | 3.6 | 7 | NOT | 207.2 | 2.8 |
| PLEMENTATION 9 | LAMP | | | | | INCLUDED | | |
| EXEMPLARY IM- | LED | 395 | 385-405 | 3.6 | 7 | NOT | 205.4 | 2.68 |
| PLEMENTATION 10 | LAMP | | | | | INCLUDED | | |
| EXEMPLARY IM- | LED | 395 | 385-405 | 3.6 | 7 | NOT | 208.6 | 2.79 |
| PLEMENTATION 11 | LAMP | | | | | INCLUDED | | |
| EXEMPLARY IM- | LED | 395 | 385-405 | 3.6 | 7 | NOT | 207.1 | 2.77 |
| PLEMENTATION 12 | LAMP | | | | | INCLUDED | | |
| EXEMPLARY IM- | LED | 395 | 385-405 | 3.6 | 7 | NOT | 207.7 | 2.73 |
| PLEMENTATION 13 | LAMP | | | | | INCLUDED | | |
| EXEMPLARY IM- | LED | 395 | 385-405 | 3.6 | 7 | NOT | 207.4 | 2.75 |
| PLEMENTATION 14 | LAMP | | | | | INCLUDED | | |
| COMPARATIVE | LED | 850 | 840-860 | 11 | 7 | INCLUDED | 198.3 | 1.79 |
| EXAMPLE 1 | LAMP | | | | | | | |
| COMPARATIVE | LED | 850 | 840-860 | 5.5 | 7 | INCLUDED | 199.0 | 1.84 |
| EXAMPLE 2 | LAMP | | | | | | | |
| COMPARATIVE | HALOGEN | 1000 | 350-3500 | 11 | 20 | INCLUDED | 197.9 | 1.75 |
| EXAMPLE 3 | LAMP | | | | | | | |
| COMPARATIVE | HIGH | — | — | — | — | — | 200.6 | 2.26 |
| EXAMPLE 4 | FREQUENCY | | | | | | | |
| | (13.56 MHz) | | | | | | | |
| COMPARATIVE | HALOGEN | 1000 | 350-3500 | 11 | 20 | INCLUDED | 194.2 | 1.60 |
| EXAMPLE 5 | LAMP | | | | | | | |
| COMPARATIVE | HALOGEN | 1000 | 350-3500 | 11 | 20 | INCLUDED | 190.1 | 1.52 |
| EXAMPLE 6 | LAMP | | | | | | | |
| COMPARATIVE | LED | 395 | 385-405 | 3.6 | 17 | NOT | 205.9 | 2.65 |
| EXAMPLE 7 | LAMP | | | | | INCLUDED | | |

As illustrated in Table 1 and Table 2, in the exemplary implementations 1 through 14, the (001) intensity of the FePt alloy composing the perpendicular magnetic layer was 205.4 or greater, and the SNR of the magnetic recording media was 2.68 dB or higher. In contrast, in the comparative examples 1 through 7, the (001) orientation of the perpendicular magnetic layer was 205.9 or less, and the SNR of the magnetic recording medium was 2.65 dB or lower.

The magnetic recording medium manufacturing methods according to the exemplary implementations 1 through 14 differs from the magnetic recording medium manufacturing methods according to the comparative examples 1 through 7 in that, after the perpendicular magnetic layer is formed on the third underlayer composed of MgO, the surface of the perpendicular magnetic layer is irradiated with the LED light from the LED light source under predetermined irradiation conditions to heat the surface of the perpendicular magnetic layer with the LED light. Further, in the magnetic recording medium manufacturing methods according to the exemplary implementations 1 through 14, the LED light having center wavelength of 395 nm or less was emitted from the LED light source. Accordingly, it was confirmed that, in the method for manufacturing a magnetic recording medium of Examples 1 to 14, it is possible to manufacture a magnetic recording medium while preventing the heat during heating of the perpendicular magnetic layer from affecting the glass substrate, the Ti-based underlayer, the soft magnetic layer, the first underlayer, the second underlayer, and the third underlayer which are located under the perpendicular magnetic layer. Thus, the magnetic recording medium according to the present embodiment can be used effectively in the magnetic read/write device.

Although the embodiments are described above, the embodiments are presented examples, and the present invention is not limited to the embodiments. The above described embodiments can be implemented in various other forms, and various combinations, omissions, substitutions, modifications, or the like can be made without departing from the scope of the invention. The embodiments and modifications thereof are included in the scope and spirit of the invention, and are included in the invention described in the claims and the scope of equivalents thereof.

This application claims priority to Japanese Patent Application No. 2022-070962 filed before the Japan Patent Office on Apr. 22, 2022, the entire contents of which are incorporated herein by reference.

### DESCRIPTION OF REFERENCE NUMERALS

10, 101: Magnetic recording medium
11: Nonmagnetic substrate
12: Soft magnetic layer
13: Underlayer
13-1: First underlayer
13-2: Second underlayer
13-3: Third underlayer
14: Perpendicular magnetic layer
15: Protective layer
100: Magnetic read/write device
102: Magnetic recording medium drive unit
103: Magnetic head
104: Magnetic head drive unit
105: Read/write signal processor

1. A magnetic recording medium manufacturing method for manufacturing a magnetic recording medium having a substrate, an underlayer, and a perpendicular magnetic layer having a L1₀ structure in this order, the magnetic recording medium manufacturing method comprising:
heating a surface of the perpendicular magnetic layer by LED light emitted from a LED light source after forming the perpendicular magnetic layer, to improve a crystal orientation of the perpendicular magnetic layer, wherein:
the underlayer includes a NaCl type compound, and
the LED light has a center wavelength of less than 500 nm.

2. The magnetic recording medium manufacturing method as claimed in claim 1, wherein the LED light emitted from the LED light source includes no LED light having a center wavelength of 500 nm or more.

3. The magnetic recording medium manufacturing method as claimed in claim 1, wherein the LED light heats a heating region having a diameter greater than or equal to 90 mm with a light intensity of 1.5 W/cm² to 15 W/cm² and a uniformity of the light intensity in the heating region within ±15%.

4. The magnetic recording medium manufacturing method as claimed in claim 1, wherein:
the underlayer includes a first underlayer in which a bcc alloy having Cr as a main component is (100)-oriented, a second underlayer in which a bcc alloy having W as a main component is (100)-oriented, and a third underlayer having MgO as the NaCl type compound as a main component, that are laminated in this order on the substrate, and
a film thickness of the second underlayer is (λ×0.1) nm or greater when the center wavelength is λ nm.

5. A magnetic read/write device comprising:
a magnetic recording medium manufactured by the method for manufacturing a magnetic recording medium as claimed in claim 1.

6. The magnetic recording medium manufacturing method as claimed in claim 1, wherein the LED light has a center wavelength of less than 395 nm.

7. A magnetic read/write device comprising:
a magnetic recording medium manufactured by the method for manufacturing a magnetic recording medium as claimed in claim 6.
